(19) United States
(12) Patent Application Publication
(10) Pub. No.: US 2024/0397122 A1
(43) Pub. Date: Nov. 28, 2024

(54) OPTIMIZED SWITCHING FROM A UNICAST CONTENT SERVER TO A MULTICAST CONTENT SERVER

(71) Applicant: ORANGE, ISSY-LES-MOULINEAUX (FR)

(72) Inventors: Hervé MARCHAND, CHATILLON CEDEX (FR); Mathieu RIVOALEN, CHATILLON CEDEX (FR)

(21) Appl. No.: 18/671,147

(22) Filed: May 22, 2024

(30) Foreign Application Priority Data
May 22, 2023 (FR) 2305026

(51) Int. Cl. H04N 21/232; H04N 21/845

(52) U.S. Cl. CPC H04N 21/2326; H04N 21/845

(57) ABSTRACT

In a method for managing access by a read device to segments of a content accessible from content servers, segments of the content are initially obtained from a first server. When an environment-related condition of said read device is reached, segments of the content are received from a second server

### CROSS-REFERENCE TO RELATED APPLICATION

This Application claims priority to and the benefit of French Patent Application No. 2305026, filed May 22, 2023, the content of which is incorporated herein by reference in its entirety.

### FIELD

Embodiments of the present disclosure relate to the field of transmission of data flows on a telecommunication network, such as data flows containing digital multimedia content, namely digital audio and/or video content also called audiovisual content. Embodiments also concern the management of access by a read device to segments of a content that are accessible from content servers. This content can be a multimedia content (e.g. video or audio-video) which can be in real-time (known as “live” content by skilled persons) or on demand (e.g., Video on Demand-VOD).

### BACKGROUND

Data flows are commonly communicated over a telecommunication network. Conventionally, such data flows, in particular of multimedia content, are divided into segments.

The segments of a data flow can be obtained with different modes. In particular, the segments can be obtained in a unicast mode e.g. according to the U-ABR mode (Unicast adaptive bitrate), or in a multicast mode e.g. according to the M-ABR mode (Multicast adaptive bitrate).

The U-ABR and M-ABR modes allow the downloading of segments of content via the technique known by those skilled in the art as “adaptive streaming”.

In a unicast receiving (or transmission) mode, the segments are transmitted between a transmitter (e.g., a content server) and a receiver (e.g., a read device). When several read devices wish to obtain the same content, the segments are transmitted to each read device independently, in as many segment flows.

The multicast receiving (or transmission) mode sets out to pool transmission towards several receivers. The receivers, who wish to obtain the content, request subscription to this service of multicast transmission. A mechanism is then set up to connect these new receivers to an existing distribution tree. This connection of the receivers is intended to optimize transmission sharing, taking into account the topology of the network.

For example, the closer one is to the content source the greater the pooling, i.e. a given segment is only transmitted once for a set of different receivers. This provides a substantial gain in bandwidth.

However, the choice between one or another of the receiving modes of segments of content raises the issue of a balance between the gain in bandwidth brought by the «multicast» mode and the connection time thereto which can be penalizing for the terminal, in particular when a user switches from one content to another (e.g., when switching between channels). This can also be the case when a change in quality is needed.

The time lag required for setting up a flow of segments in multicast mode could create starvation of the terminal which will no longer be able to produce the multimedia content for the user. In the case of video content, this will be interrupted at the last image decoded from the last received segment (freezing of the video).

Such interruptions are not acceptable for users. Therefore, there is a need to improve the current proposals of the prior art.

### SUMMARY

Embodiments of the present disclosure generally operate to improve the general experience of users of read devices.

For this purpose and in a first aspect, embodiments of the present disclosure can be implemented by a method for managing access by a read device to segments of a content accessible from content servers, in which segments are initially obtained from a first server, and segments continue to be obtained from a second server when an environment-related condition of said read device is reached.

According to some embodiments, one or more of the following characteristics which can be used alone or in partial combination with each other or in full combination with each other:
Said first server is associated with a unicast receiving mode and/or said second server is associated with a multicast receiving mode. It is therefore possible, for obtaining the segments of content, to trigger switching from unicast to multicast receiving mode as a function of the environment of the read device, in particular to take into account the local situation thereof.

Said environment-related condition of said read device comprises a condition related to information associated with the segments obtained by said read device. This information allows consideration to be given to the content of a buffer memory of the read device, to decide whether or not to trigger switching to the second content server.

Said read device transmits information on its environment to said management entity, and said management entity determines whether said condition is reached as a function of said information. This management entity is therefore able to manage choice of the moment when switching could be carried out as a function of the information transmitted by the read device on its environment. This embodiment allows centralization of specific functions in the management entity, thereby making it compatible with any read device.

Said information is transmitted together with requests for segments transmitted by said read device. This brings savings in exchanges of messages on the local network, and the management entity therefore has the information that will be needed when choosing which content server should be used for the requested segment.
Said information comprises a time length associated with the segments contained in the buffer memory of said read device. The management entity is therefore able to choose which content server should be requested for the desired segment as a function of the time length of the content contained in the buffer memory of the read device, and is able to estimate whether this time length allows absorbing of the time needed for switching to the second content server.
Said information can also or alternatively comprise a number of segments contained in the buffer memory of said read device. This embodiment also enables the management entity to estimate whether the content of the buffer memory allows absorbing of the time needed for switching to the second content server.

Some embodiments of the present disclosure concern a management entity managing access by a device to segments of a content accessible from content servers, comprising a processor configured to start initial receiving of segments from a first server, and continued receiving of segments from a second server when an environment-related condition of said read device is reached.

Further embodiments concern a gateway, e.g. a home gateway comprising a management entity such as previously described.

Some embodiments concern a computer program configured for implementation on a monitoring device, the program comprising code instructions which, when executed by a processor, carries out the steps of the method, such as the method previously described.

Additional embodiments of the present disclosure concern a computer readable data storage medium on which there is stored at least one series of program code instructions for implementation of the method, such as the method previously described.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a simplified diagram of a telecommunication network, in which embodiments of the present disclosure may be implemented.

FIG. 2 is a diagram of a timeline, in accordance with embodiments of the present disclosure.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art.

As will be appreciated by one of skill in the art, embodiments of the present disclosure may be embodied as methods, systems, devices, and/or computer program products. Accordingly, embodiments of the present disclosure may take the form of an entirely hardware embodiment, an entirely software embodiment or an embodiment combining software and hardware aspects. The computer program or software aspect of embodiments of the present disclosure may comprise computer readable instructions or code stored in a computer readable medium or memory. Execution of the program instructions by one or more processors (e.g., central processing unit) results in the one or more processors performing one or more functions or method steps described herein. Any suitable patent subject matter eligible computer readable media or memory may be utilized including, for example, hard disks, CD-ROMs, optical storage devices, or magnetic storage devices. Such computer readable media or memory do not include transitory waves or signals.

Certain features described in the context of various embodiments are not to be considered as essential features of those embodiments unless the embodiment is inoperative without those features.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or may be shown in block diagram form in order to not obscure the embodiments in unnecessary detail.

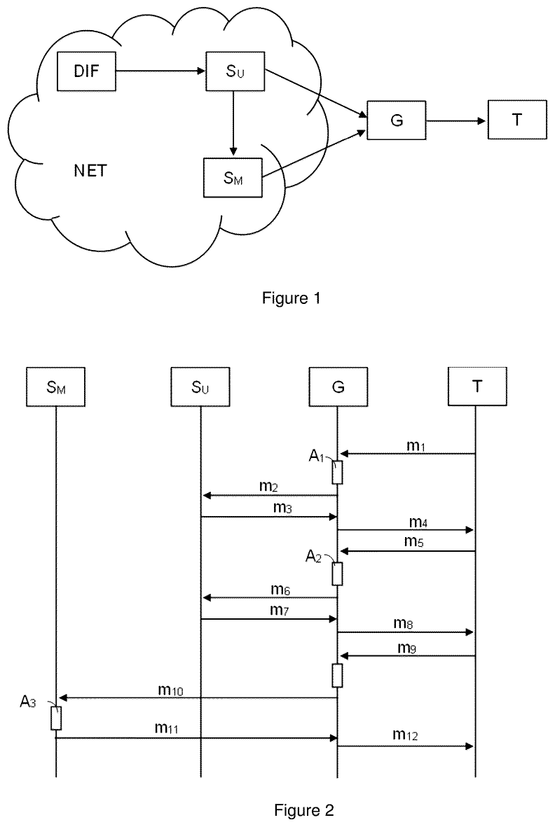

FIG. 1 illustrates a telecommunication network, NET, allowing the conveying of a flow of data formed of segments of content (e.g., multimedia content), towards one or more terminals or read devices T.

These terminals or read devices can be of different types, such as a mobile terminal, connected television, computer, etc.

The mobile terminal can typically be of smartphone type or a tablet computer, adapted to receive flows of multimedia content and to reproduce the same on an interface of the terminal, or connected to said terminal.

The television can have a built-in connection for receiving flows of multimedia content or it can operate as a monitor or display that receives the multimedia content from an associated external device, such as an HDMI dongle connected to the television, that receives the flows of the multimedia content.

One example of an external device communicating with a television or display is a Chromecast. A Chromecast is a device for real-time reading of multimedia flows (multimedia gateway) developed and marketed by Google. The device connects to the HDMI port of a television and communicates, via Wi-Fi connection, with another device connected to the Internet (computer, smartphone, tablet . . . ), to display on the television the multimedia content received from an application compatible with Google Cast technology, or from the Google Chrome navigator on a computer, or from some Android devices.

In this latter case, the read device of multimedia content can be this associated device.

The data flows can be multimedia flows. These typically comprise video or audio-video flows (or contents). They may also be audio flows (music, radio broadcasts . . . ), or interactive contents (including games). They may be contents on demand, or “live” content. This transmission mode can be a transmission mode of Internet Protocol Television (IPT), but other transmission modes can evidently be envisaged.

In general, the contents are divided into segments.

When an adaptive streaming mode of Adaptive Bit Rate (ABR) type is used, the segments can be available in several resolutions. A so-called “manifest” file enables the read devices T to choose a resolution as a function in particular of their local environment.

These resolutions correspond to qualities of the video (and/or audio) content and hence to different bit rates on the telecommunication network.

The qualities available on ABR can vary as a function of the video streaming platform used, but in general and currently the usual qualities comprise:

Very low quality: often adapted for users with very slow or unstable Internet connections, this quality can have a resolution of 240p and bit rate of 200 kbps.

Low quality: this quality is suitable for more stable Internet connections but still relatively slow, with a resolution of 360p and bit rate of 400-700 kbps.

Standard quality: this quality is suitable for most Internet connections, with a resolution of 480p or 720p and bit rate of 800 kbps to 2 Mbps.

High quality: this quality is suitable for fast, reliable Internet connections with a resolution of 1080p and bit rate of 2-5 Mbps.

Very high quality: this quality is suitable for very fast Internet connections, with a resolution of 4K and a bit rate higher than 10 Mbps.

It is important to note that the available qualities may vary depending upon the bandwidth capacities of the user and of the network, and upon the quality and complexity of the streamed video content. The “manifest” file can then be modified according to variations at the network or at the content server.

This content can initially be available on a DIF source.

This source is connected to a Content Delivery Network (CDN), which forms a kind of overlay on the telecommunication network, NET, such as the Internet.

The content delivery network CDN comprises one or more separate content servers, S_{U}, S_{M}. A first server S_{U} can be a unicast server for example, and a second server S_{M} can be a multicast server.

Typically, the segments of the DIF source are transmitted to a first unicast server, and to a second multicast server. The multicast server, or “multicaster”, can receive the segments from the unicast server S_{U} when a decision is taken to make transmission possible in multicast. This decision can be taken for example by the first content server, S_{U}, or by a monitoring device, not illustrated, having knowledge of the number of read devices wishing to receive a given content.

The content delivery network also comprises terminal equipment. This terminal equipment can form a gateway G between the public network on which the content delivery network CDN is deployed, and a private network to which different content read devices T are connected.

This local network can be a network installed at the user (home network) allowing the connection of different equipment or content read devices both between each other and with the gateway to the public network. Said local network can conform to different technologies, e.g. Wi-Fi, Ethernet™, Bluetooth, etc., or to a combination of several of said networks.

As previously mentioned, the unicast server SU provides manifest files to the read devices T via the respective gateways G. From these manifest files, the read devices T can send requests for downloading a segment at the chosen resolution among those available in the manifest.

More specifically, the read devices can access the manifests and the segments of content via management entities which can be embedded for example on these gateways G.

The gateways G can therefore group together several functions. However, in some embodiments, these functions can be distributed among different items of equipment (which can then form a distributed gateway).

The multicast server S_{M} transmits the segments in a distribution tree, independently of the read devices T which have subscribed for reception thereof. The nodes of the distribution tree take charge of subsequent transmission to the leaves of the tree composed of the management entities.

In one embodiment, it is considered that these management entities are embedded on the gateways G. In particular, they can be operated by an assembly of software modules deployed on one or more processors contained in this gateway.

These management entities can provide manifests to the content read devices T, according to the flows of multicast segments to which they have subscribed. From the viewpoint of these read devices, T, these management entities therefore form the entry to the content delivery network, CDN. Said management entity can therefore correspond to a “nano CDN” or “n-CDN”, known to those skilled in the art, such entity in this case only concerning access to multicast flows.

A proposed method is a method for managing access by a read device T, to segments of a content accessible from content servers, S_{U}, S_{M}. This method comprises initial obtaining of segments from a first server, S_{U}, and continued obtaining of segments from a second server, S_{M}, when an environment-related condition of the read device T is reached.

This method therefore allows large flexibility in switching between a first and second content server.

In one embodiment, the first server is a unicast server, S_{U}, and the second server is a multicast server, S_{M}.

Therefore, at a first stage, the read device T receives segments from a unicast server and, after a certain time, it can be connected to a multicast server which transmits thereto the following segments. In this manner, it is not necessary for the read device T to wait for connection to the distribution tree to start receiving segments of the desired content.

Recovery of the first segment in unicast is faster than in MultiCast. To recover the first segment in multicast, as will be seen below, subscription must previously be made with a channel by requesting membership with a delivery group (IGMP Join) and the flow routed. It is therefore advantageous to recover the first segments in unicast to initiate reading as fast as possible, then to switch to multicast to benefit from the gain in bandwidth on the operator's network.

The segments can be recovered at a faster rate than the user consumption rate for use thereof, in particular for display on a screen associated with the read device T. The segments are stored in a buffer memory associated with the read device T. The number of stored segments can vary over time as a function of consumption rate (normally constant) and acquisition rate (which can depend both on the transmission network between the content server and the gateway G, and on the environment of the read device T including connection thereof to the gateway G).

Once a sufficient number of segments is stored, the obtaining of segments can continue from the multicast server. The time needed for connection to the multicast distribution tree is then absorbed by the time preceding this switching with the storing of a sufficient number of segments in the buffer memory associated with the read device T. In other words, the depth of the buffer memory allows absorbing of the time needed for switching to the multicast server.

In this manner, the switch from one server to another (in particular from a unicast server to a multicast server) is fluid and transparent for the user of the read device T. In particular, the audio-visual content is produced without interruption.

FIG. 2 illustrates a timeline for one example of implementation of a method between a read device T, a gateway G, a first content server, unicast, S_{U} and a second content server, multicast, S_{M}.

At a first stage, the read device T transmits a request m₁ to the gateway identifying the desired content. The request m₁ is able to identify a particular segment to be received.

At this stage, the segments of content are obtained from the first content server, S_{U}.

A management entity, embedded on the gateway G, can be in charge of determining from which server the segments requested by a read device T must be obtained.

This determination can be performed by verifying an environment-related condition of the read device T. This environment can be characterized by different factors. In particular, they can relate to the read device T itself and/or to the user, or else to the read application used and the configuration parameters thereof, and/or to the communication network connecting the read device T to the gateway G.

For example, one condition can concern information associated with the segments obtained by the read device. In particular, this information can concern the segments obtained and contained in the buffer memory associated with the read device T.

This information can relate to a number of segments obtained or a time calculated from these segments, knowing the duration of each segment. The condition can therefore be that of comparing this number, or this time, with a threshold.

This threshold can be fixed, but it can also depend upon the user or the read application which reads the segments of content to be received by the user.

Therefore, this condition can concern an application need, or a user-related need to be more or less close to real-time: for example, for the live retransmission of a sports event it may be desirable that reading of the audio-video content is only delayed by minimum number of segments relative to the source. The threshold can then be fixed as a function of this need.

Also, a condition can relate to the stability of the communication network between the management entity and the read device (e.g. Wi-Fi communication or other wireless technology). In one embodiment, the threshold can be caused to depend on these dynamic aspects of network stability.

Still further conditions can evidently be determined which, for example, will cause the threshold to change over time. However, it is possible that other conditions or other embodiments do not cause the condition to depend on comparison with a threshold.

Also, the condition to be verified for triggering the switch to the second content server may comprise one or more of these conditions.

On receiving the message m1, the management entity of the gateway G, triggers a verification process A1 of the determined condition. In this example, it is assumed that the condition is not verified, for example because the read device does not have a sufficient number of segments stored in the buffer memory.

In one embodiment, the read device T transmits information on its environment to the management entity. In particular, it can transmit thereto information associated with the segments obtained by the read device (number of segments stored in the buffer memory for example).

This information can be transmitted in one same message m₁ as the segment request.

Once it has been verified that the condition is not met, the management entity transmits a request m₂ to the chosen server, here the first server S_{U}, identifying the segment requested by the read device T.

In a message m₃, the first server S_{U} transmits this segment to the gateway G which, in a message m₄, retransmits the same to the read device T. This device can store this segment in the buffer memory where it will be “consumed” by a read application of audio-video content.

The read device T can transmit a new request, m₅, for a new segment. The read device, or more specifically the read application deployed on this device, can be responsible for triggering this new request m₅. In one embodiment, this request m₅ can be transmitted with information on the segments stored in its buffer memory.

At A₂, the management entity of the gateway G can again verify whether the condition is verified.

It is assumed that the read device T already has at least one segment previously obtained and stored in its buffer memory, but that the number of segments or the duration corresponding to these segments is not sufficient. As previously, the sufficient or insufficient nature can be determined by comparison with a predefined threshold.

The determined condition is therefore not met, and it is decided to continue obtaining segments from the first content server, i.e. the unicast content server S_{U}.

The management entity transmits a request m₆ to the first content server S_{U} identifying the segment requested by the read device T.

In a message m₇, the first server S_{U} transmits this segment to the gateway G which, in a message m8, retransmits the same to the read device T. This latter device can store this segment in the buffer memory where it will be “consumed” by a read application of audio-video content.

The read device T can transmit a new request, m₉, for a new segment. In one example of embodiment, this request m₉ can be transmitted with information on the segments stored in its buffer memory.

The management entity of the gateway G can again verify whether the condition is verified.

It is assumed this time that the determined condition is verified i.e. that the read device T has transmitted information indicating that it has a number of segments, or corresponding duration of segments, that is sufficient compared with a predefined threshold.

This condition being verified, the management entity can trigger the switch to continued obtaining of segments from the second content server, i.e. the multicast content server, S_{M}. The management entity of the gateway G can then transmit a request message m₁₀ for a new segment (identifying the desired segment) to the second content server SM.

In other words, this switching can generate a change in receiving mode from unicast mode to multicast mode.

The switching over to a multicast mode can depend on the multicast technology used.

In multicast mode, the terminals e.g. the management entity of the gateway G, interested in receiving a content must join a group of terminals having requested subscription to the same content using for example an IGMP protocol (Internet Group Management Protocol) for IPv4 terminals, or the MLD protocol (Multicast Listener Discovery) for IPV6 terminals. A terminal must be a member of a group to receive a given multicast flow.

The IGMP protocol, version 3 thereof, can conform to RFC 3376 of the IETF standards organization.

According to this protocol, the management entity sends a message to a Rendezvous Point router (RP) to subscribe to the multicast group corresponding to the content desired by the read device T. This message can be an IGMP Membership Report.

This Rendezvous Point router is chosen in a distribution tree of the multicast content as a function of a topological criterion. Typically, the management entity subscribes to the closest RP router, so that transmission of the content between the content source and this RP router is the longest possible, to optimize pooling of transmissions.

The RP router holds a table of the members of the multicast group. When it receives multicast data, it sends these solely to the entities which have subscribed to the group. Therefore, after subscription, the management entity can start to receive the segments in multicast mode.

This process schematically illustrated at step A₃ in FIG. 2, can take substantial and uncertain time.

However, according to the proposed method, by subjecting the triggering of switch to multicast mode to the heeding of a condition relating to the segments already obtained (and stored in the buffer memory of the read device), it is possible to provide safeguard against starvation of the read device i.e. against the brief absence of segments to be read and produced, while awaiting reception of the segments in multicast mode.

The second content server S_{M} (i.e. the multicast server) can transmit a segment in the distribution tree, and this segment can therefore be obtained by the management entity of the gateway G (message m₁₁).

On receipt of a segment, the management entity retransmits the obtained segment to the read device, in a message m₁₂. This transmission can be made in unicast mode since it concerns transmission between only two parties.

Conventionally, transmission in multicast reduces the load on the operator's telecommunication network. In addition, the subscription time to the channel in multicast mode does not freeze reading of the video content on the read device T. Benefit is therefore drawn from the advantages of the multicast receiving mode without enduring the disadvantages which may occur in the mechanisms of the prior art.

This proposed mechanism can be applied to other types of servers other than the unicast/multicast server pair. In particular, it applies in the general case when switching from a first server to a second server is likely to lead to temporary interruption of the receiving of segments by the read device, for example on account of the time lag for connecting to the second server.

The proposed mechanism safeguards against this time lag by subjecting the switch to an environment-related condition of the read device. In particular, in one embodiment, this switch is subjected to sufficient content in the buffer memory of the device so that it can continue to read the content using the buffer memory during the connection set-up time. It can therefore be guaranteed that the buffer memory will not be emptied before set-up of the connection to the second server, so that there is no read interruption. In this manner, the switch between the first and second content server appears transparent for users of the read device T.

It is also possible to take into consideration other environment-related conditions for the read device T, so that the switch to the second content server only takes place when this environment corresponds to requisites associated with the second server.

The present invention is evidently not limited to the described and illustrated embodiment and examples. In particular, numerous variants within the reach of persons skilled in the art can be made thereto.

Although the embodiments of the present disclosure have been described with reference to preferred embodiments, workers skilled in the art will recognize that changes may be made in form and detail without departing from the spirit and scope of the present disclosure.

What is claimed is:

1. A method for managing access by a read device to segments of a content accessible from content servers, the method comprising:
initially obtaining segments of the content from a first server; and
when an environment-related condition of said read device is reached, obtaining segments of the content from a second server.

2. The method according to claim 1, wherein said first server is associated with a unicast receiving mode and/or said second server is associated with a multicast receiving mode.

3. The method according to claim 1, wherein said environment-related condition of said read device comprises a condition concerning information associated with the segments obtained by said read device.

4. The method according to claim 3, wherein said read device transmits information on its environment to a management entity, and said management entity determines whether said condition is reached as a function of said information.

5. The method according to claim 4, wherein said information comprises a time length associated with the segments contained in a buffer memory of said read device.

6. The method according to claim 5, wherein said information is transmitted with requests for segments transmitted by said read device.

7. A management entity of access by a read device to segments of a content accessible from content servers, comprising a processor configured to initially start obtaining segments of the content from a first server, and continued obtaining of segments from a second server when an environment-related condition of said read device is reached.

8. A gateway comprising the management entity according to claim 7.

9. A non-transitory computer readable medium comprising a computer program stored thereon, which when executed by a processor of a management entity, configure the management entity to implement a method for managing access by a read device to segments of a content accessible from content servers, the method comprising:
initially obtaining segments of the content from a first server; and
when an environment-related condition of said read device is reached, obtaining segments of the content from a second server.

10. The non-transitory computer readable medium according to claim 9, wherein said first server is associated with a unicast receiving mode and/or said second server is associated with a multicast receiving mode.

11. The non-transitory computer readable medium according to claim 9, wherein said environment-related condition of said read device comprises a condition concerning information associated with the segments obtained by said read device.

12. The non-transitory computer readable medium according to claim 11, wherein the method includes:
receiving information from the read device on its environment; and
determining whether said condition is reached as a function of said information.

13. The non-transitory computer readable medium according to claim 12, wherein said information comprises a time length associated with the segments contained in a buffer memory of said read device.

14. The non-transitory computer readable medium according to claim 13, wherein the method includes receiving said information along with requests for segments from the read device.
